(19) United States
(12) Patent Application Publication
(10) Pub. No.: US 2005/0278279 A1
(43) Pub. Date: Dec. 15, 2005

(54) Native libraries descriptor with reference counting

(76) Inventors: Petio G. Petev, Sofia (BG); Dimitar P. Kostadinov, Sofia (BG); Krasimir P. Semerdzhiev, Sofia (BG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/856,137

(22) Filed: May 28, 2004

(51) Int. Cl. G06F 7/00

(52) U.S. Cl. 707/1

(57) ABSTRACT

Embodiments include a system for managing files or software components by use of a descriptor file. The descriptor file may track references to the file or software component by other files and software components. A software component that has no references to it may be removed from a system.

### BACKGROUND

1. Field of the Invention

The embodiments of the invention relate to software installation applications. Specifically, embodiments of the invention relate to a mechanism to manage the deployment and removal of software components by tracking the attributes of the components including the number of other software components referencing the software components.

2. Background

A cluster system is utilized to provide a set of services and resources to a set of client computers. The cluster system includes a collection of server nodes and other components that are arranged to cooperatively perform computer-implemented tasks, such as providing client computers with access to the set of services and resources. A cluster system may be used in an enterprise software environment to handle a number of tasks in parallel. A cluster system is scalable and has the flexibility to enable additional cluster elements to be incorporated within or added to the existing cluster elements.

Traditional client-server systems provided by a cluster system employ a two-tiered architecture. Applications executed on the client side of the two-tiered architecture are comprised of a monolithic set of program code including a graphical user interface component, presentation logic, business logic and a network interface that enables the client to communicate over a network with one or more servers in a clustered system that provides access to a set of services and resources.

The “business logic” component of the application represents the core of the application, i.e., the rules governing the underlying business process (or other functionality) provided by the application. The “presentation logic” describes the specific manner in which the results of the business logic are formatted for display on the user interface.

The limitations of the two-tiered architecture become apparent when employed within a large enterprise system. For example, installing and maintaining up-to-date client-side applications on a large number of different clients is a difficult task, even with the aid of automated administration tools. Moreover, a tight coupling of business logic, presentation logic and the user interface logic makes the client-side code very brittle. Changing the client-side user interface of such applications is extremely difficult without breaking the business logic, and vice versa. This problem is aggravated by the fact that, in a dynamic enterprise environment, the business logic may be changed frequently in response to changing business rules. Accordingly, the two-tiered architecture is an inefficient solution for enterprise systems.

In response to limitations associated with the two-tiered client-server architecture, a multi-tiered architecture has been developed. In the multi-tiered system, the presentation logic, business logic and set of services and resources are logically separated from the user interface of the application. These layers are moved off of the client to one or more dedicated servers on the network. For example, the presentation logic, the business logic, and the database may each be maintained on separate servers. In fact, depending on the size of the enterprise, each individual logical layer may be spread across multiple dedicated servers.

This division of logical components provides a more flexible and scalable architecture compared to that provided by the two-tier model. For example, the separation ensures that all clients share a single implementation of business logic. If business rules change, changing the current implementation of business logic to a new version may not require updating any client-side program code. In addition, presentation logic may be provided which generates code for a variety of different user interfaces, which may be standard browsers such as Internet Explorer® or Netscape Navigator®.

A multi-tiered architecture may be implemented using a variety of different application technologies at each of the layers of the multi-tier architecture, including those based on Java 2 Enterprise Edition created by Sun Microsystems, Santa Clara, Calif. (“J2EE”), the Microsoft .NET Framework created by Microsoft Corporation of Redmond, Wash. (“.Net”) and/or the Advanced Business Application Programming (“ABAP”) standard developed by SAP AG. For example, in a J2EE environment, the business layer, which handles the core business logic of the application, is comprised of Enterprise Java Bean (“EJB”) components with support for EJB containers. Within a J2EE environment, the presentation layer is responsible for generating servlets and Java Server Pages (“JSP”) interpretable by different types of browsers at the user interface layer.

Applications and services deployed on an application server may include a set of shared software components. Software components are files, archives, or similar data that form an application, service or a portion of an application or service. The update or reconfiguration of the applications and services on an application server may result in the removal or addition of software components that are referenced by or reference other software components. As a result, a software components that had been shared between applications or services remain on an application server even though the applications or services that utilized this software component are no longer present. A large number of unused software components accumulate in the file system of the application server that are not used, wasting space in the file system. The excess software components are not easily removed because it is difficult to determine if any other software components may reference a given software component.

### SUMMARY

Embodiments include a system for managing software components by use of a descriptor file. The descriptor file may track references to the software component by other software components. A software component that has no references to it may be removed from a system.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a block diagram of one embodiment of a software component management system using a descriptor file.

FIG. 2 is a flowchart of one embodiment of a process for managing software components during a deployment operation.

FIG. 3 is a flowchart of one embodiment of a process for managing software components during an undeployment operation.

FIG. 4 is a diagram of one embodiment of a computer system running the software component management system.

FIG. 5 is a diagram of one embodiment of a cluster system running the software component management system.

### DETAILED DESCRIPTION

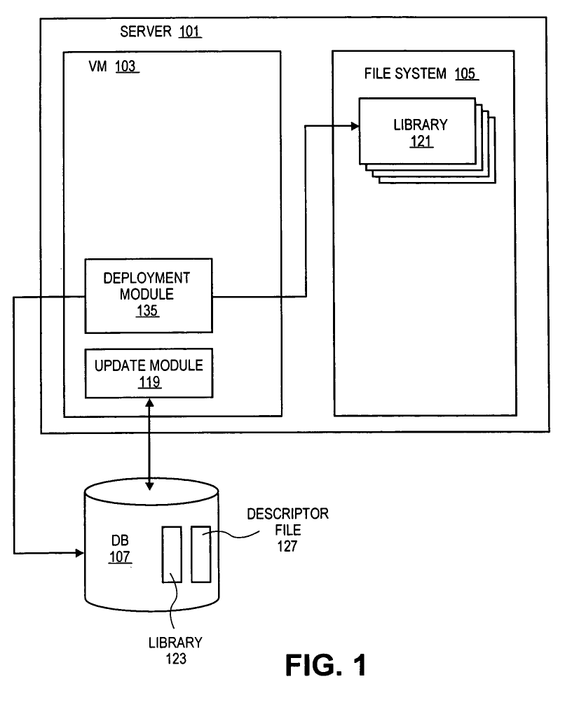

FIG. 1 is a diagram of one embodiment of a computer system utilizing a software component management system. In one embodiment, the software component management system operates on a local machine and a database 107 to track the attributes and references to software components of applications and services that are stored in a file system 105 of the local machine or database 107 which may be in communication with the local machine. As used herein, a software component may be a file, set of files, archive, set of archives or similar data or grouping of data. In one embodiment, the local machine is an application server 101. Application server 101 may provide access to services and resources for a set of clients. Clients may be remote computers, a local application, and similar programs local to the server or remote from the server. In one embodiment, the services and resources provided by application server 101 may be applications and services related to enterprise software and resources. In another embodiment, the local machine may be any machine in communication with database 107.

In one embodiment, file system 105 may be used to store software components deployed to the local machine from database 107. In one embodiment, the software components may be part of the applications and services provided by application server 101. In one embodiment, software components stored by file system 105 may include archive files. An archive file is a file that may contain multiple files in a compressed or encrypted format. In one embodiment, an archive file may contain or be a portion of a set of software components. In one embodiment, an archive file may be a java archive file. A java archive file may be used to store code for class files to be used to instantiated objects in a java virtual machine 103. In another embodiment, other types of archive files may be supported by the software component management system including zip files, software deployment archives, and similar file types. In one embodiment, an archive file may store other types of files including binary files, data, text files and similar file types. In one embodiment, native libraries 121 may be stored in file system 105. Native libraries 121 may be software components that contain data and programs designed to be shared by multiple other software components, applications, services or similar programs.

In one embodiment, the local machine may execute applications and services using a virtual machine 103 environment. Virtual machine 103 may be a java virtual machine including a java virtual machine based on the java 2 enterprise edition specification J2EE) or similar virtual machine. Virtual machine 103 may support any number of applications and services including an update module 119 or similar applications or programs. Applications, services and similar programs and modules may be executed by the local machine in the form of objects or sets of objects.

In one embodiment, an update module 119 may be executed, instantiated or similarly provided by the local machine. Update module 119 may manage the deployment, undeployment and removal of software components from the local machine. Update module 119 may communicate with database 107 to determine which software components are to be deployed, undeployed or removed from the local machine. In one embodiment, database 107 and the local machine may maintain indexes of the configuration for the local machine. When the indexes do not match then the update module retrieves missing or modified software components from database 107 or removes software components from the local machine.

In one embodiment, database 107 may maintain a descriptor file 127 describing the attributes of a software component in database 107. A single descriptor file or set of descriptor files may track the attributes of all software components in database 107 or a subset of these software components. In another embodiment, separate descriptor files 127 may be used for each software component in database 107. In one embodiment, database 107 is a relational database. Descriptor files and software components may be stored in categorical tables or similar storage structures in database 107.

In one embodiment, update module 119 utilizes descriptor files to determine the appropriate software components to retrieve from database 107 and which software components to remove from its filesystem. For example, database 107 may have an updated library 123 component to deploy to the local machine. On start up, update module 119 may determine that library component 121 must be updated. Update module 119 may check an associated descriptor file 127 to determine which library component matches the local system. Descriptor files may track attributes of a software component including: operating system, data model, unicode support, reference count, path in database, file name and similar attributes. If, for example, a local machine is a Linux 32-bit system that supports the unicode character set, then update module 119 may consult descriptor file 127 to find an entry matching these attributes and retrieve the appropriate component using the database pathname and filename.

In one embodiment, the update module may also check a descriptor file when undeploying an application, service, or software component. If the file descriptor for a software component indicates a reference count is greater than zero then a file or software component may be retained because other applications or software components still need the software component in the local machine. If however, a reference count is zero or less then a software component may be removed as it is no longer needed in the local machine. A reference count may me decremented below zero due to errors in counting references. For example, if an application or software component related to library 121 is being removed from the local machine then a check of the descriptor file in database 107 may be made to determine if the entry with the matching attributes has a reference count of zero.

In one embodiment, the local system may also include a deployment module 135. In another embodiment, deployment module 135 may be located on any machine in communication with database 107. Deployment module 135 may be a set of services, software components or applications that allow a deployment or undeployment of software components to database 107. The software components to be deployed or undeployed may be selected by a user. During deployment and undeployment operations, deployment module 135 updates descriptor files including reference counts for each software component.

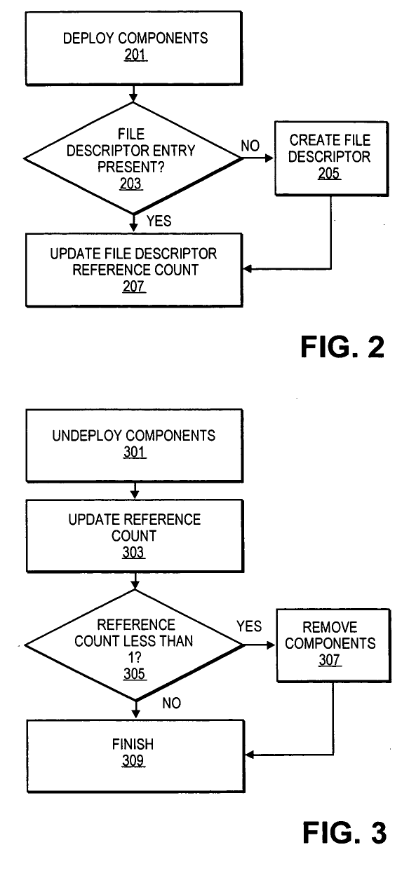

FIG. 2 is a flowchart of one embodiment of a process for managing software components in a system during a deployment operation. In one embodiment, a deployment module or similar application or service initiates a deployment operation (block 201). A user may select a set of software components to be deployed to a database. These software components may subsequently be deployed to a set of applications servers or similar computer systems by the update module of each server or system by download from the database. A check may be made during the deployment operation to determine if a descriptor file entry is present for each of the software components being deployed to the database (block 203).

In one embodiment, if a descriptor file or entry in a descriptor file for a software component to be deployed in the database is not present, then the deployment module may initiate the creation of a descriptor file or entry (block 205). The descriptor file may contain an entry for each variation of a software component based on the attributes of the software component. In another embodiment, the descriptor file may only contain data for a single software component. An entry may specify each attribute for a software component including, operating systems supported, unicode support (or non-unicode support), dataform support (e.g., 32 bit platform, 64 bit platform or similar platform), database pathname or location, filename, reference count and similar attributes of a software component.

In one embodiment, if a descriptor file or entry is already present or if recently created for each software component to be deployed then the deployment module may initiate the update of each descriptor file entry for the software components to be deployed (block 207). The descriptor file may be updated to reflect additional or decreased references to a software component. If a reference count reaches zero the software component may be removed from local machines thereby freeing up storage space on those machines.

FIG. 3 is a flowchart of one embodiment of a process for managing software components in a system during an undeploy operation. In one embodiment, a deployment module or similar program may initiate an undeploy operation (block 301). The deployment module may specify a set of software components to be undeployed from a target database. Local machines may also undeploy the specified set of software components or a subset of the software components on their file systems when an update module on the local machine checks the database to determine changes in configuration for its platform or system type.

In one embodiment, the deployment module may initiate an update of the descriptor file entry for each software component to be undeployed including an update of a reference counter in the descriptor file entry (block 303). Some software components may be utilized by multiple applications, services or similar programs. Undeployment of one of these programs may not result in the undeployment of a shared software component. For example, native library components are often shared by multiple applications and services. Removal of one of these services does not necessitate the removal of the native library. However, if no application or service requires the native library it may be removed to free up storage space. In one embodiment, the descriptor file tracks the number of applications, services or software components that utilize a software component in a reference count portion of a descriptor file entry for the software component.

In one embodiment, after a reference count has been updated a check may be made to determine if the reference count is less than one (block 305). If a reference count is less than one then no application, service or software component may need the software component for a machine with a designated set of attributes matching the software component. During an update procedure, an update module may make a reference count check for a software component. The update module may remove the software component from a local file system if a reference count in the descriptor file is less than one (block 307). If a reference count is not less than one then no special procedure is required and normal operation of the database and local system continues (block 309). A software component with a reference count of zero may be maintained in a database in case of future need. In another embodiment, the software component may be removed from the database during the undeployment operation if the reference count is less than one. In one embodiment, the descriptor file entry for software components with a reference count of less than one may be retained for reference and possible future use.

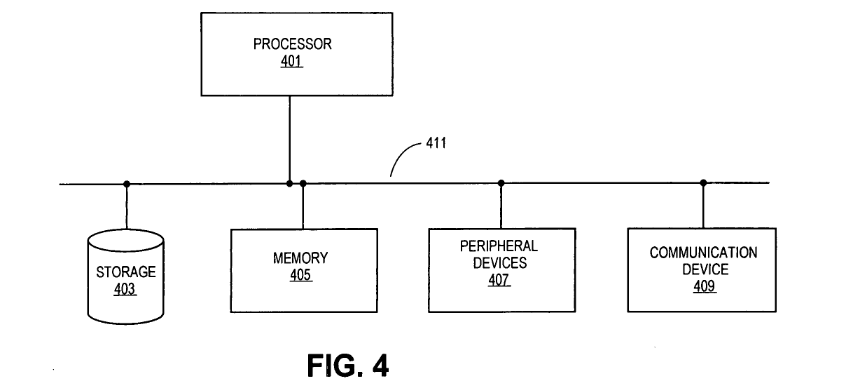

FIG. 4 is a block diagram of an exemplary computer system for executing a software component management system. In one embodiment, the computer system may include a processor 401 or set of processors to execute the software component management system, virtual machine, applications, services and similar programs. The processor may be a general purpose processor, application specific integrated circuit (ASIC) or similar processor. Processor 401 may be in communication via a bus 411 or similar communication medium with a memory device 405. Memory device 405 may be a system memory device or set of devices such as double data rate (DDR) memory modules, synchronized dynamic random access memory (SDRAM) memory modules, flash memory modules, or similar memory devices. Memory device 405 may be utilized by processor 401 as a working memory to execute the virtual machine, applications, the offline deployment system and similar programs.

In one embodiment, the computer system may include a storage device 403. Storage device 403 may be a magnetic disk, optical storage medium, flash memory, or similar storage device. Storage device 403 may be utilized to store files, including a file system, program files, software component management system files, temporary files, index files and similar files and data structures. The computer system may also include a set of peripheral devices 407. Peripheral devices 407 may include input devices, sound system devices, graphics devices, display devices, auxiliary storage devices, or similar devices or systems utilized with a computer system.

In one embodiment, the computer system may include a communication device 409. Communication device 409 may be a networking device to allow the computer system and applications, services and similar programs to communicate with other computers, applications, services and similar programs. In one embodiment, communication device 409 may be utilized to communicate with a remote database and send or transfer files to the database.

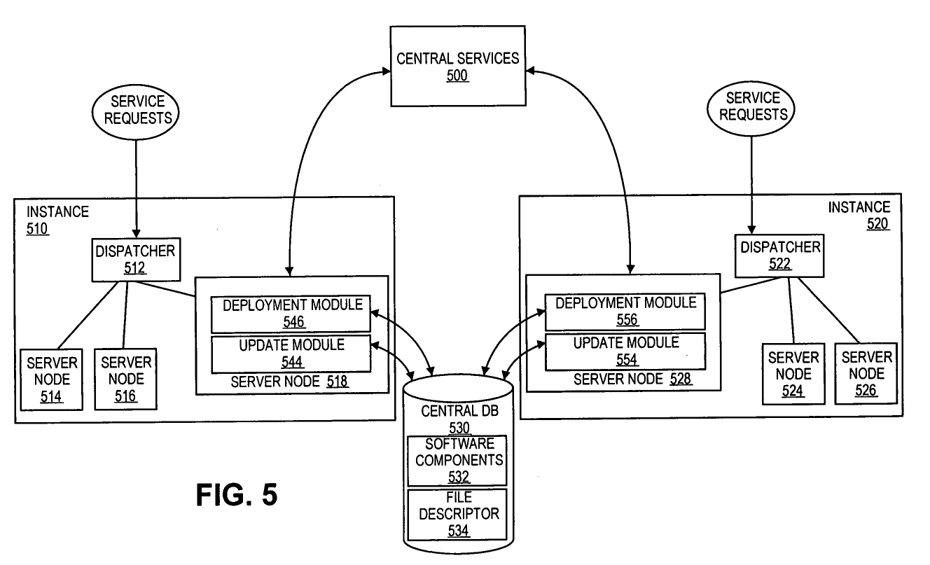

FIG. 5 is one embodiment of a cluster system that includes a software component management system. In one embodiment, the system architecture may include a central services instance 500 and a plurality of application server instances 510, 520. In one embodiment, the application servers are organized into groups referred to as “instances.” Each instance includes a group of redundant application servers and a dispatcher for distributing service requests to each of the application servers. A group of instances may be organized as a “cluster.” The application server instances, 510 and 520, may each include a group of application servers 514, 516, 518 and 524, 526, 528, respectively, and a dispatcher, 512, 522, respectively.

The central services instance 500 may include a set of shared services such as a locking service, a messaging service and similar services. The combination of the application server instances 510, 520 and the central services instance 500 may be the primary constituents of the cluster system. Although the following description will focus primarily on instance 510 for the purpose of explanation, the same principles and concepts apply to other instances such as instance 520.

In one embodiment, the application servers 514, 516, 518 within instance 510 may provide business and/or presentation logic for the network applications supported by the cluster system. Each of application servers 514, 516 and 518 within a particular instance 510 may be configured with a redundant set of application logic and associated data. In one embodiment, dispatcher 512 distributes service requests from clients to one or more of application servers 514, 516 and 518 based on the load on each of the servers.

In one embodiment, application servers 514, 516 and 518 may be Java 2 Enterprise Edition (“J2EE”) application servers which support Enterprise Java Bean (“EJB”) components and EJB containers (at the business layer) and Servlets and Java Server Pages (“JSP”) (at the presentation layer). In another embodiment, the cluster system, applications servers and update module may be implemented in the context of various other software platforms including, by way of example, Microsoft .NET platforms and/or the Advanced Business Application Programming (“ABAP”) platforms developed by SAP AG.

In one embodiment, applications server 518 may include a deployment module 546. Deployment module 546 may provide an interface for a client to determine a set of software components 532, applications, services or similar programs or data to be deployed, removed or undeployed from database 530. Deployment module 546 may be located on any application server, cluster or machine in communication with database 530. A single deployment module 546 may be present in a cluster or multiple deployment modules may be present. Deployment module 546 may update descriptor files 534 in database 530 during deployment and undeployment operations. For example, deployment module 546 may update reference counts for software components related to a deployment or undeployment.

In one embodiment, update modules 544, 554 may communicate with database 530 to update each application server in accordance with a configuration of services, applications and software components deployed in database 530. In one embodiment, database 530 may contain files and data to be deployed to an array of different platforms. The applications, services and similar programs deployed on database 530 may be stored in archive files. In one embodiment, archives may be java file archives. Updating an application server in accordance with a deployment on database 530 may include removing or undeploying files from the application server that are no longer a part of the deployment present on database 530. For example, update module 554 may download software component 532 from database 530 to install as a software component 556 on application server 528. Update module 554 may check file descriptor 534 to determine if any software components on application server 528 should be removed because the reference count for the software component is less than one. Each application server may have an update module 544, 554 in communication with database 530.

In one embodiment, update modules 544, 554 may utilize only the software components, services and applications that are designated for deployment on the platform of the application server associated with update modules 544, 554. For example, some cluster or application servers may operate on a Windows platform, while other clusters or application servers may operate on a Linux platform. The database may include descriptor file or similar data structure to identify which software components are to be deployed to each platform or to platforms with specific properties (e.g., 64-bit or 32-bit platforms).

In one embodiment, the software component management system may be implemented in software and stored or transmitted in a machine-readable medium. As used herein, a machine-readable medium is a medium that can store or transmit data such as a fixed disk, physical disk, optical disk, CDROM, DVD, floppy disk, magnetic disk, wireless device, infrared device, and similar storage and transmission technologies.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. A system comprising:
a first server to provide a service to a client, the service having a software component; and
a storage system in communication with the server to store a descriptor of the software component, the software component descriptor tracking the number of references to the software component from other software components.

2. The system of claim 1, further comprising:
an update module to deploy the set of software components to the first server and to adjust the descriptor of the software component to reflect a change in the number of references.

3. The system of claim 1, further comprising:
an update module to remove another software component from the first server and to adjust the descriptor of the software component to reflect a change in the number of references, if the number of references is less than one then the removal application removes the software component.

4. The system of claim 1, where in the software component is a native library.

5. The system of claim 1, wherein the storage system contains a database to store the software component.

6. A method comprising:
tracking references to a software component in a descriptor file for the software component; and
removing the software component when a number of references to the software component by other software components reaches zero.

7. The method of claim 6, further comprising:
tracking attributes of the software component in the descriptor file.

8. The method of claim 6, wherein the software component is a native library.

9. The method of claim 6, further comprising:
storing the descriptor file in a local storage system.

10. The method of claim 6, further comprising:
adjusting a reference count in a descriptor file during one of a deployment operation and a removal operation.

11. The method of claim 6, further comprising:
removing the software component from a web application server.

12. An apparatus comprising:
a software component for a web application server; and
a software component descriptor to track references to the software component module from other software component modules.

13. The apparatus of claim 7, further comprising:
a web application server in communication with the software component database.

14. The apparatus of claim 12, further comprising:
a software component deployment module to initiate the removal of the software component module when a number or references in the software component descriptor module is less than or equal to zero.

15. The apparatus of claim 12, wherein the software component descriptor module comprises:
a reference count which is adjusted by the software component deployment module when initiating one of a deployment and a removal operation.

16. An apparatus comprising:
means for calculating a number of references to a software component; and
means for removing the software component when the number is less than one.

17. The apparatus of claim 16, further comprising:
means for adjusting the number of references during a deployment operation.

18. The apparatus of claim 16, further comprising:
means for adjusting the number of references during a removal operation.

19. The apparatus of claim 16, wherein the software component is a native library.

20. The apparatus of claim 16, further comprising:
means for tracking a set of file properties.

21. A machine readable medium, having instructions stored therein which when executed cause a machine to perform a set of operations comprising:
tracking a references to a shared file in a file descriptor; and
removing the shared file from a file system when the references to the shared file total less than one.

22. The machine readable medium of claim 21, having further instructions stored therein which when executed cause a machine to perform a set of operations further comprising:
storing platform information related to the shared file in the file descriptor.

23. The machine readable medium of claim 21, further comprising:
modifying a reference count field in the file descriptor after one of a deployment and removal operation.

24. The machine readable medium of claim 21, wherein the shared file is a native library.
